(19) United States
(12) Patent Application Publication
(10) Pub. No.: US 2011/0302513 A1
(43) Pub. Date: Dec. 8, 2011

(54) METHODS AND APPARATUSES FOR FLEXIBLE MODIFICATION OF USER INTERFACES

(76) Inventors: Fredrik Ademar, Loddekopinge (SE); Erik Mänsson, Malmo (SE); Johan Frej, Goteborg (SE); Mikael Johansson, Malmo (SE)

(21) Appl. No.: 13/130,831

(22) PCT Filed: Nov. 20, 2009
(86) PCT No.: PCT/EP2009/065546

§ 371 Date: Aug. 10, 2011

Related U.S. Application Data
(60) Provisional application No. 61/117,432, filed on Nov. 24, 2008.

(51) Int. Cl. G06F 3/048

(52) U.S. Cl. 715/762

(57) ABSTRACT

A method for modifying a user interface of an apparatus is disclosed. The method comprises the steps of: receiving user interface key data, wherein the user interface key data comprises at least one reference to at least one user interface modification algorithm, generating user interface user interface modification data based on the user interface modification algorithm, and modifying the user interface based on the user interface modification data. An apparatus performing the method is also disclosed.

In this text we describe a system for allowing flexible modification of the user interface of mobile devices. We have defined the term “user interface” of a device as all points of contact between the user and the device. This includes, but is not limited to, the graphical user interface of the device.

Traditionally, there has been two ways of allowing modification of user interfaces in mobile devices:

The mobile device contains all graphical elements and other resources needed for modifying the UI from the day it is manufactured.

The graphical elements and resources needed for modifying the UI are transferred to the mobile device as they are needed.

A problem with the first alternative is that the variation and number of possible modifications that can be made to the UI is limited by what and how many graphical elements and other resources the mobile device contains.

A problem with the second alternative is that modifications will typically require large amounts of data to be transferred to the device. Data channels that can handle these amounts of data are not always available, and when they are they are often costly to use.

Attempts at solving these problems typically include the use of compression algorithms to reduce the size of data that need to be transferred to the device. Even though the use of compression, the amount of data that typically needs to be transferred to enable flexible user interface modification is too large to be transferred to the device over low bandwidth channels.

### BRIEF LIST OF FIGURES

FIG. 1: Describes a device containing algorithms and basic data for use in the algorithms. The figure also shows how user interface key data is used to select and give input to the algorithms and how the results from the algorithms are used to modify the UI of the device.

FIG. 2: User interface key data is used to preview user interface changes. The key data is then transferred to the mobile device where the algorithms will produce the same user interface modifications that were previewed.

FIG. 3: User interface key data fed to algorithms in order to preview the resulting user interface modification.

FIGS. 4-9: Demonstrating an example use for the invention: Personalized SMS messaging.

FIG. 10: Demonstrating an example use for the invention: Updating the background image in a device.

FIG. 11: Illustrating an implementation an algorithm that could be used in the invention. The algorithm builds a large image from several smaller images that can be seamlessly combined.

FIG. 12: An example of a way of creating user interface key data. A user starts out with a style, or set of key data, and can then select different styles in order to influence his current style by them.

FIG. 13: Another way of creating user interface key data. The user adjusts parameters in the key data by moving his finger over a touch sensitive surface.

FIG. 14: An example of an image decomposed into basic graphical building blocks.

FIG. 15: An example of how a real-time sensor input—in this case a squeeze force detector—can act as one user interface key data parameter, controlling the scale of the image generated for the user interface.

FIG. 16: An example of how a real-time sensor input—in this case an ambient temperature sensor—can act as several user interface parameters, controlling coloring and choice of images to use in the user interface.

FIG. 17: An example of how a real-time sensor input—in this case an accelerometer—can act as one user interface parameter, controlling the appearance of one aspect of the user interface.

### THE INVENTION

### Introduction

The invention is a system for allowing flexible modification of the user interface of mobile devices, without the need for transferring large amounts of data.

The system does not rely on data compression as such, but rather on the idea that the sender and the receiver of the user interface modifications agree on a set of algorithms that are used to produce the modifications. What is transmitted is not the compressed data needed for the modifications but rather information about which algorithms that produce the needed data, and optionally input to the algorithms.

In this system the mobile device contains a set of algorithms that can be used to generate UI changes from user interface key data.

User interface key data are small pieces of data that tell the device what algorithms it should use to generate the user interface modifications. User interface key data could be small enough to be transferred in an SMS which traditionally contains no more than 160 characters. User interface key data could be created using an editor, which would translate a users design into data suitable for input into the device's algorithms.

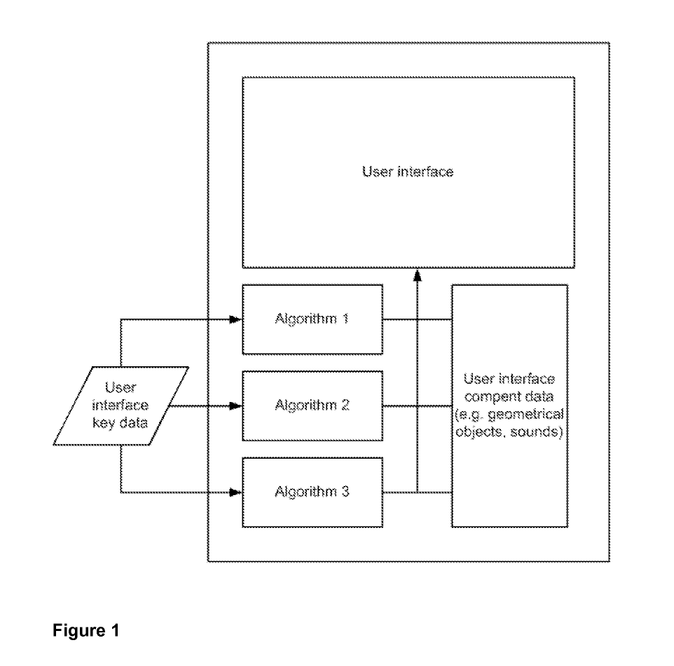

In this system the device could also contain basic graphical elements and other data, to be used as starting points for the algorithms. See FIG. 1.

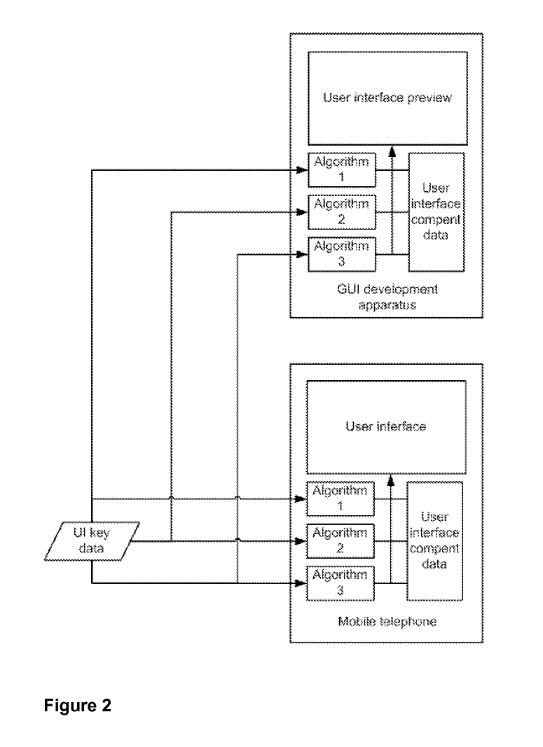

In order to modify the user interface on a device one would transfer user interface key data to the device where it would be used to point out, and give input to, the algorithms residing in the device. The output from the algorithms would be used in modifying the user interface. See FIG. 2.

The user interface key data could be transferred to the target device in any number of ways: over low-bandwidth channels like SMS or radio protocols like RDS, or higher bandwidth channels like GPRS or Wi-Fi. User interface key data could also be entered manually, transferred to the device from a printed form or it could be created on the target device.

### Algorithms

The system described in this text provides a way of producing UI modifications in a mobile device. In this system the device contains a number of algorithms, that all share the characteristic that they can produce input to the user interface from user interface key data.

The device could also contain basic graphical elements and resources that could be used in the different algorithms, as described in FIG. 1. Such components could include:
Data for use in image generation algorithms.
Basic graphical elements, like triangles, circles, and squares.
Fonts, both regular font formats and fonts described in vector format.
Sound data.
Basic 3D mesh building blocks.

UI modifications are performed by supplying input to one or a set of the device's algorithms, and then using the output from the algorithms in modifying the user interface. The output from algorithms could also be used as input to the same, or other, algorithms.

The system does not limit what algorithms could be used, examples of algorithms include:
Image generation algorithms, otherwise typically used for procedural generation of textures. These algorithms could be used to generate images for use in the user interface, for example background images.
Algorithms for drawing preloaded graphics to the screen. If the device contains basic graphical building blocks like circles and rectangles these algorithms could be used to draw them to different parts of the screen.
Algorithms for combining preloaded general symbols like circles, squares, and triangles using boolean operations in order to create more advanced graphical shapes.
Algorithms for manipulating fonts by applying effects like dissolve and rasterize to them. These algorithms could be used to several different looks from just one font.
Vector manipulation algorithms for performing operations on vector fonts and graphics.
Sound generation and manipulation algorithms. Algorithms might for example modify the amplitude and frequency of sounds already on the device in order to create sounds of a different character. Echoes and other effects could also be added to sounds.
Texture synthesis algorithms which create larger images from smaller sample images that might be preloaded or fetched from the mobile device's image gallery.
Algorithms for generation and manipulation of 3D meshes. These algorithms could be used to modify 3D objects, like 3 dimensional icons that could be warped and twisted in different ways.
Algorithms for generating self-similar fractals, like L-systems. These kind of algorithms might be used to create the perception of a tree growing in the user interface.
Nature inspired generation algorithms, like algorithms for generating volumetric smoke and the game of life algorithm.
Algorithms for manipulating haptics, or the tactile feedback in a device.
Algorithms for manipulating 3D shaders in order to affect the rendering of 3D objects.
Algorithms implemented for efficient execution on certain hardware, for instance the shader unit on a dedicated graphical processing unit.

### User Interface Key Data

The user interface key data are typically made up of short text strings or numbers, and are designed to provide meaningful input to the algorithms while maintaining a small footprint. The user interface key data contains information on what algorithms to use to generate a user interface modification. The user interface key data could also contain information like:

References to graphical resources and other data to use in the algorithms.

Data to use as start data in the algorithms.

Information on what to do with the results from the algorithms.

User interface key data could be generated through the use of an editor but also using other techniques, for example barcode scanning, analyzing image data or through some randomizing process.

Similar to barcode scanning, i.e. using a built-in sensor to read external information, any other sensor monitoring the environment in which the device is present could be used to generate user interface key data. Examples being: Accelerometer data, compass/magnetometer data, ambient light, ambient temperature, GPS position, cell tower triangulation position, signal strength, battery charge, pressure/force sensors, barometric pressure, proximity to other objects, touch position on one or several touch sensitive surfaces, time passed since various events.

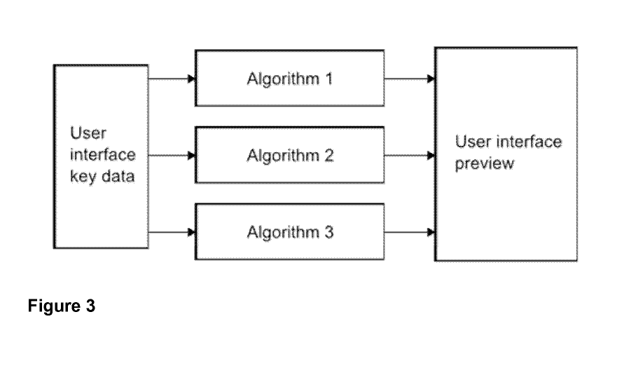

In the case of using an editor to create the user interface key data the user could have access to the same algorithms as in the target device, which would make it possible for the user to experiment using different data. By previewing the output from the algorithms the user could find a combination of user interface key data that represents the UI modification he wishes to perform. FIG. 3 illustrates how user interface key data can be previewed.

The system described in this text could contain functionality for optimizing the size of the user interface key data by making them more or less accurate.

This could for example be useful when transmitting the data in an SMS, where a less accurate key data could be used if there is not enough space left in the SMS for a more accurate, and larger, key data.

### Examples

Here are some examples on how the system described in this text could be used:

### Personalizing SMS Messages

In this example users are able to personalize the presentation of SMS messages they send to other users. The scenario involves two users, the sender and the receiver. The sender composes an SMS on a computer or a device, and sends it to the receiver who views it on his mobile device.

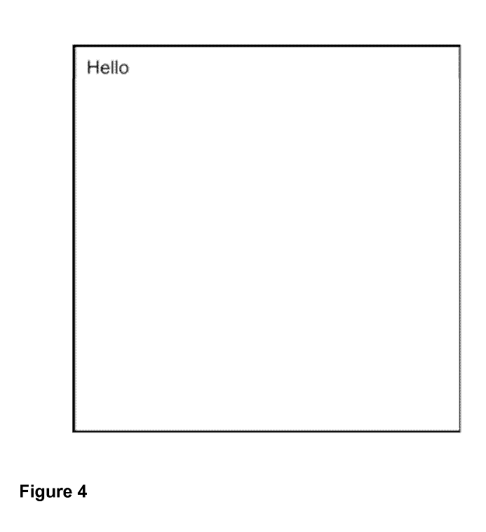

FIG. 4: The sender creates an SMS message.

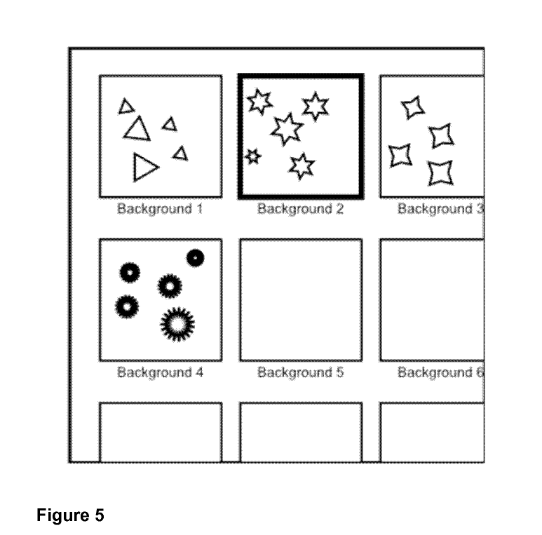

FIG. 5: The sender chooses to select another background. This opens up a screen where the sender can choose between lots of different backgrounds. The backgrounds are generated using the same algorithm that is available in the receiver's device. Each background variant represents the output from the background generation algorithm when it is supplied with a certain input data.

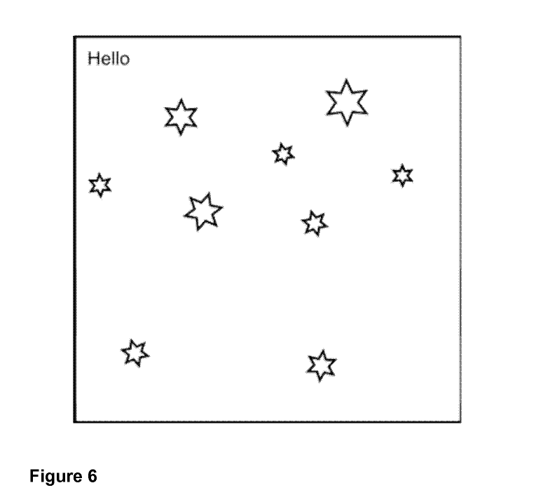

FIG. 6: The sender previews the composed SMS with the background he has chosen.

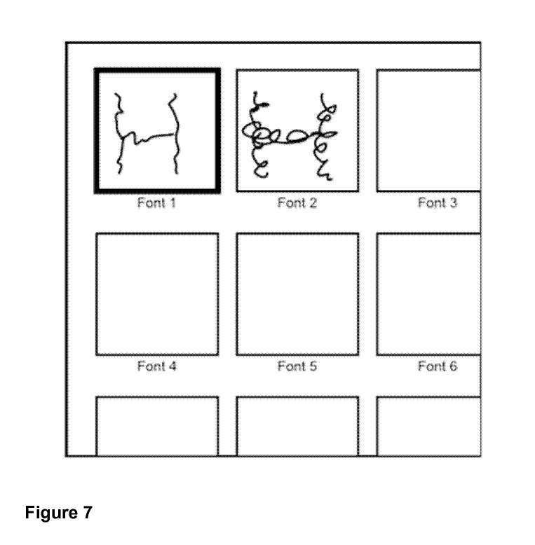

FIG. 7: The sender opts to choose a font for his message. He gets to choose from a large selection of different font styles. Each of the styles represents the output from the same font modification algorithm that is present in the receiver's system, after giving it different input.

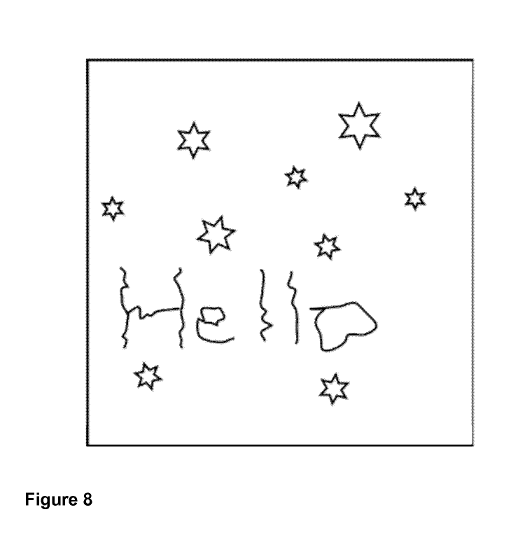

FIG. 8: Again, the sender previews his message.

Once the sender is satisfied with the look of his message he sends it to the receiver. Two things are transferred to the receiver's device in an SMS message:
The text
The user interface key data containing references to the two algorithms to use for generating the font and the background image, as well as input data to the two algorithms.

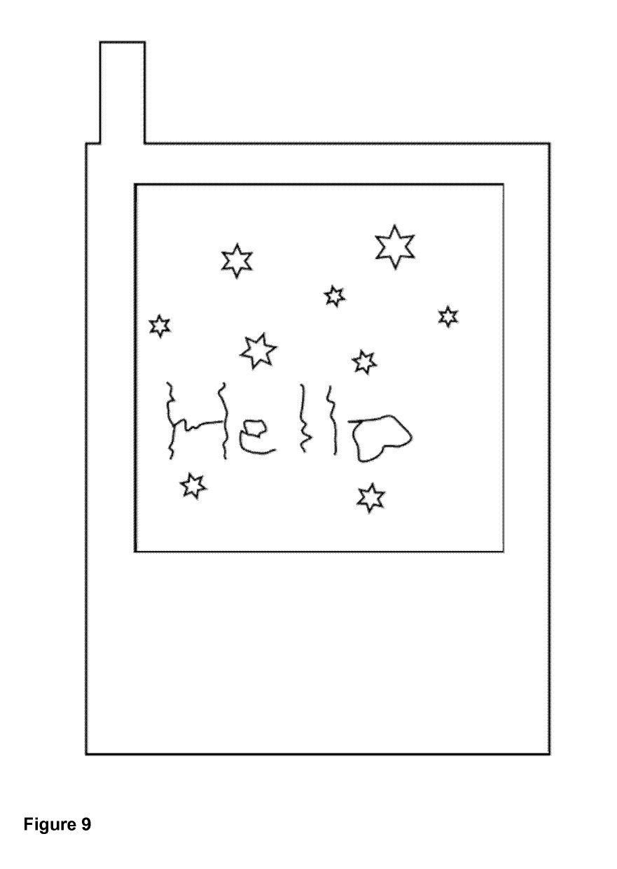

FIG. 9: In the receiver's device the algorithm input is extracted from the user interface key data and used as input to the algorithms. The algorithms create the font and the background image and the SMS message is displayed in the same way it was previewed on the sender's device.

### Updating a Background Image

In this example the mobile device contains an algorithm for generating images.

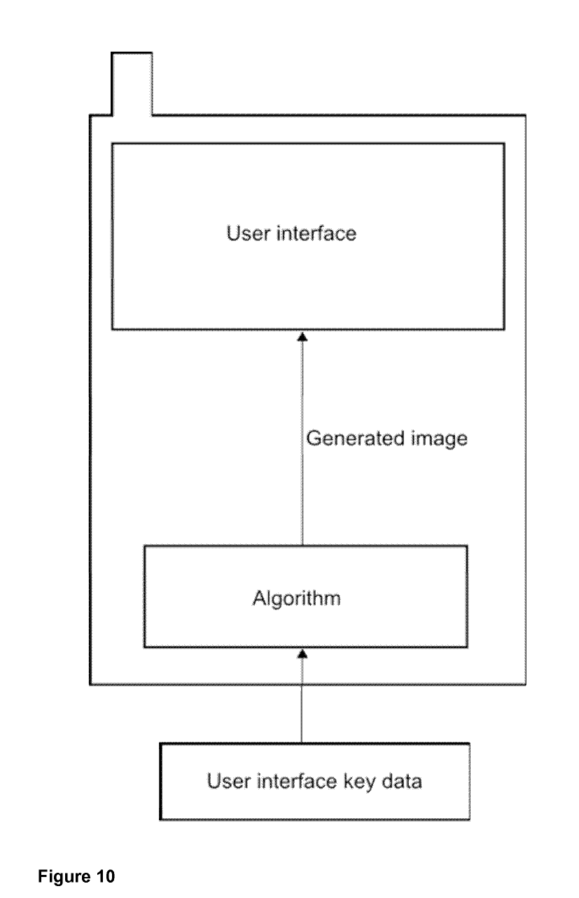

The algorithm is fed user interface key data, containing a string that the algorithm interprets to understand specifics about how it should generate the image. The user interface key data could also contain information telling the device what it should do with the generated image. In this case the device updates its user interface, using the newly generated image as the background image. See FIG. 10 for an illustration.

### Continuous Updates of User Interface Component Based on Real-Time Key Data

This meta-example highlights the fact that if one or more of the key data values changes, this may trigger the algorithms to regenerate the desired user interface component.

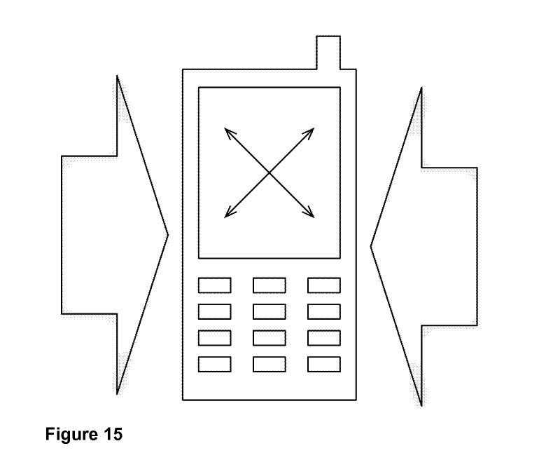

Consider for example the previous example where a background image was generated from user interface key data. One could let one key data parameter be the pressure with which the user holds or squeezes the device and let this affect the scaling of the generated image. This could enable a “bulging” effect of the user interface when the device is squeezed. See FIG. 15.

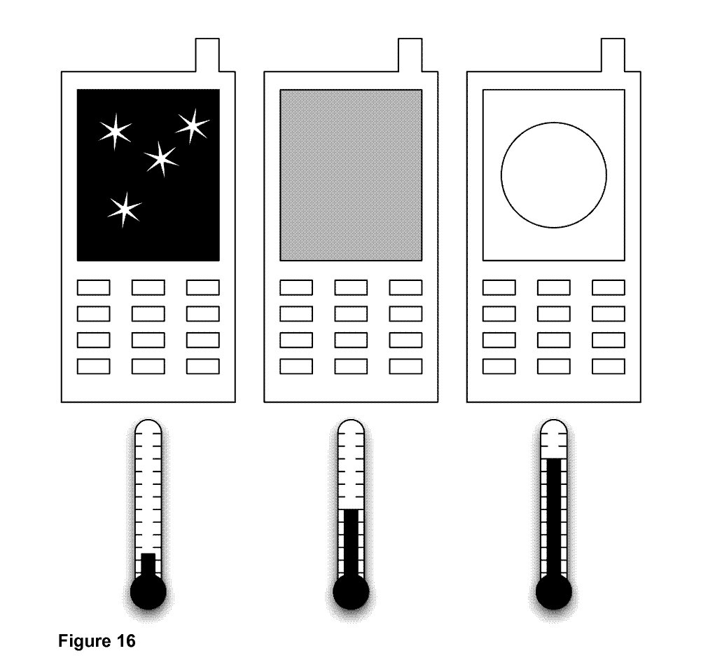

Another example of a real-time key data parameter could be the ambient temperature, which affects the overall color scheme of the user interface and also what image assets are used. See FIG. 16.

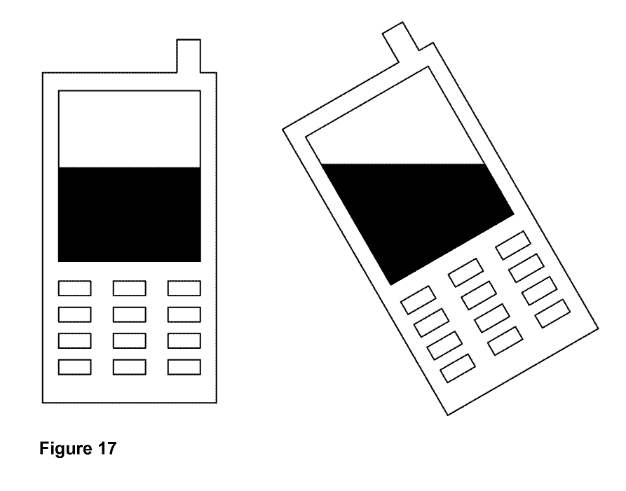

Yet another example of a real-time key data parameter could be detection of device orientation using an accelerometer, which affects the orientation of an element in the user interface, in this case countering the effect of the device rotation. See FIG. 17.

In another aspect of the invention, the real-time sensor key data parameter only affect the user interface if further actuation of the originating sensor will result in an event affecting the user interface state, i.e. activating a feature, launching some application, triggering an animation etc. In some of the examples above: The “bulging background” effect could only be active if further/harder squeezing of the device actually led to the activation of a certain user interface feature, for instance to launch the web browser or alarm clock; The orientation change of a user interface element based on device orientation would only be active if changing device orientation would actually lead to another change in user interface state, such as changing screen orientation or switching a camera from portrait to landscape mode. This aspect of the invention highlights how to give the user a clue to what sensor are active and what interactions have the potential to change the state of the user interface instead of surprising the user as the change/event happens.

### Utilizing Dedicated Hardware for Running the Algorithms

Some of the algorithms could be implemented as vertex- and pixel shaders on a dedicated Graphical Processing Unit (GPU) and directly draw the generated graphics to the screen based on the key data provided to it.

### Transferring User Interface Key Data in a Printed Form

Since the footprint of user interface key data is kept small it is possible to distribute it using lots of different mediums. One way of taking advantage of this could be to distribute user interface changes via printed media.

User interface key data that affects the user interface in a desired way can be printed on paper, for example in magazine ads, on packaging, movie tickets and on price tags. By interpreting the user interface key data, for example using the camera and character recognition software, the user interface of user's devices could be modified. This would for example make it possible to theme a mobile device to match the characteristics of things a user likes.

### Utilizing Left Over Space in an SMS

Left over space in SMS messages could be used to transmit data. One might, for example, transmit small pieces of some data in each SMS that is sent to a receiver, utilizing the unused characters in the SMS. When all pieces of the original data have arrived, which could happen days later, they could be used to perform some operation, for example on the user interface of the receiving device.

Letting Users Share their User Interfaces

The user interface key data that represents the user interface on a user's device could be transferred to other user's devices, using mediums like Bluetooth radio, email, SMS, Wi-Fi. by transferring user interface data like this from one device to another users could share their user interfaces with each other. Users could be able to modify their user interfaces and then propagate the changes, as user interface key data, to other users.

This approach to sharing user interfaces could also involve gaming. Users could user the user interfaces on their devices as parts of the gaming experience. A user could, for example, cast a spell on a friend's device, thereby making the user interface on that device look bad.

Allowing Users to Request More Information about a Service

Users of services like radio on their mobile devices could use the system described in this text to obtain more information about that service.

Here is an example of how this could work:
A radio application in a mobile device allows the user to request the theme of the currently playing radio channel.
The radio application sends an SMS request to the radio service.
The radio service answers with an SMS containing user interface key data that describes the particular radio channels UI theme.
The device interprets the user interface key data, supplies the input to the correct algorithms which produce the graphical elements and other resources that are needed for modifying the user interface.
The user interface is modified, and now follows the graphical theme of the radio station.
   Example of Algorithm that could be Used in the Invention

The algorithm combines several visual components into a more complex appearance. The visual components can be of various kinds, such as images, animations and vector graphics or a group of other visual components. Information about how the visual components can be combined is also used as input to the method. That information can either be manually specified or automatically computed.

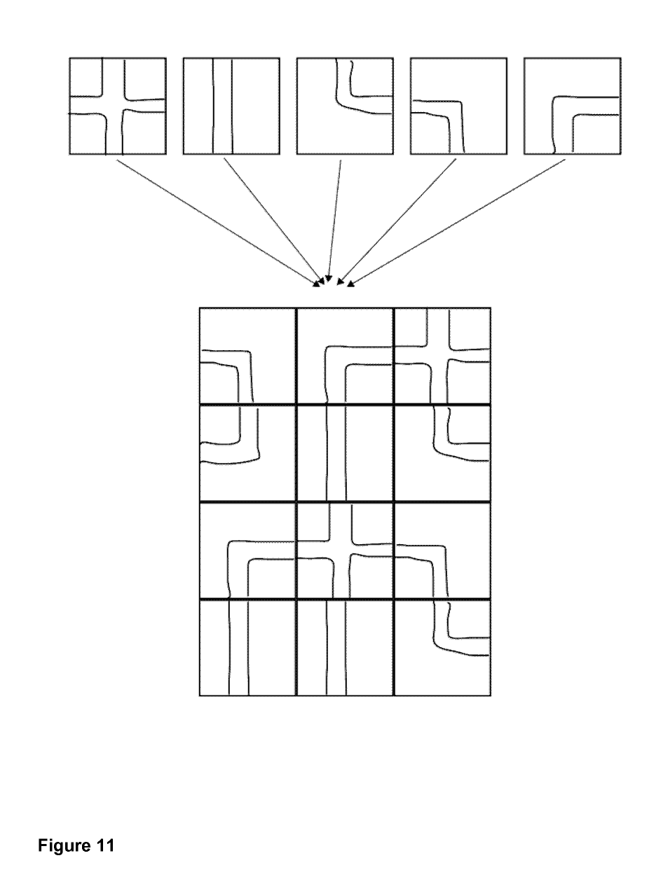

The following describes one implementation of such an algorithm, and how it could be used in the invention described in this text:
The device contains a set of images, see FIG. 11. These images are designed to be able to be aligned seamlessly adjacent to each other in certain patterns. The way the images can be aligned is known to the algorithm.
The algorithm takes as input a few weighted numbers that describe the frequency with which the different images should be used. The weighted numbers could be transferred to the device as user interface key data.
By selecting images based on the weighted numbers and combining them in a seamless pattern, the algorithm can create infinitely large images from the base images, see FIG. 11. This could be used to create a scrolling background image for a list that never stops scrolling. When a new area of the scrolling background image is needed the algorithm would just generate a bit more.

### Creating User Interface Key Data by Blending Presets

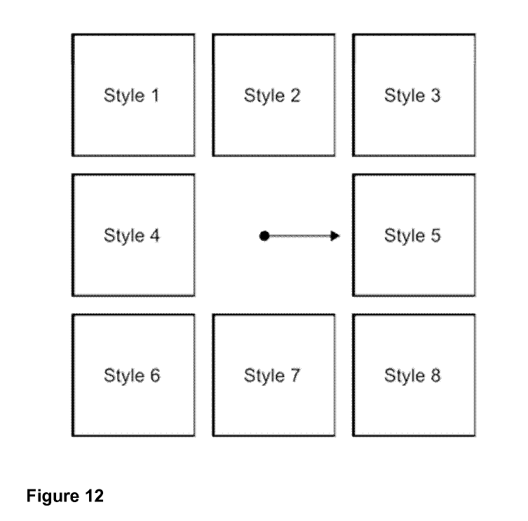

One way of creating user interface key data could be that the user is presented with a number of styles, or rather combinations of UI modifications. The user would be able to browse the styles, and pick his favorite one. The user could then be able to blend the style he picked with other styles, creating a new style that is influenced by the two other styles. The user could then be able to continue influencing his style by choosing other styles to blend with his. See FIG. 12 for an illustration of how a user can select different styles in order to influence his current style by them.

Editors for this system could present users with lots of choices, making it look like there are lots, or even infinite numbers, of preloaded graphics and other resources to choose from while the choices are really generated as the user browses them.

### Another Editor for Creating User Interface Key Data

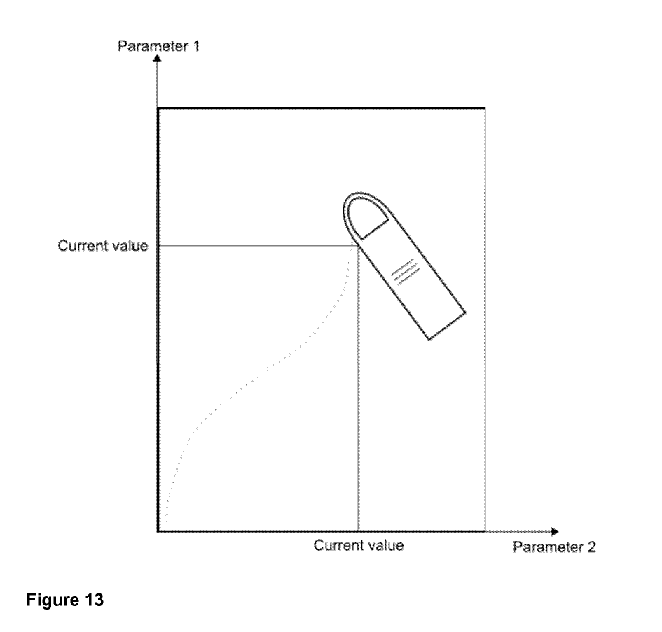

Composing user interface key data that result in interesting user interface modifications could be done through experimentation. An editor that allows the user to experiment until he finds interesting key data could be realized using a touch sensitive surface. Each point on the surface would represent a pair of values, the value corresponding to an imagined x-axis running from left to right and the value corresponding to the y-axis running from the bottom to the top, see FIG. 13.

These two values would be used in creating user interface key data. When selecting one of these points the user would get a preview of how the user interface would be changed by the resulting user interface key data. By moving his finger over the surface the user would be able to preview a large variation of user interface key data in a short time, finding the key data that produce user interface modifications he likes.

In one example of this editor, the axis could represent the color and the speed of particles moving around on the background image. By experimentation, the user could find a combination of particles he likes. The user interface key data would include the values of the two axis, making it possible to recreate the same combination of particles from the user interface key data.

Extracting User Interface Key Data from Photos

User interface key data could be extracted from information in photographs. For example, a mobile device could contain logic for creating user interface key data by looking at what colors are common in an image. The mobile device could contain algorithms for creating background images in the color that is most common in an image. This would allow users to create a green background by photographing something that is green.

### Interactive Modification of User Interface

Interactive modification of the user interface of a device could be accomplished by using the system described in this text and asking the device user for information. The device could ask the user for input to the user interface modification algorithms in the form of taking a photograph.

### Editor for Decomposing Image Data

One of the proposed algorithms that could be part of this invention is one that combines several basic graphical elements, using boolean operations. These graphical elements could come preloaded on the device and might include a triangle, a circle, a square and other graphical building blocks. User interface key data could be pointing out what graphical elements to combine and what boolean algorithm to use when combining them, thereby making it possible to create more advanced graphical patterns from the basic graphics on the device.

In order to create this type of user interface key data an editor could be used. This editor would be able to decompose more advanced image data into the basic graphical building blocks and the boolean operations needed to recreate the image data.

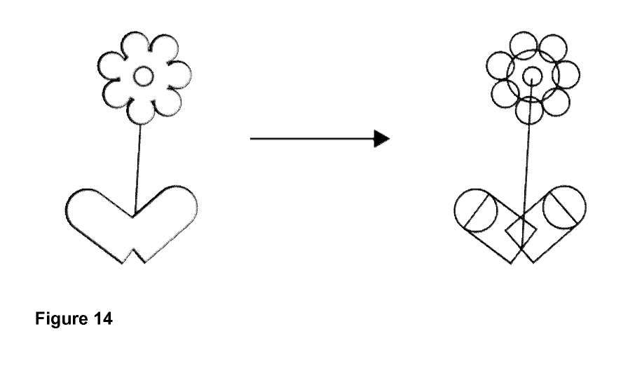

Using this editor, users could take an image or other graphics they have created and create user interface key data from which algorithms as closely as possible can recreate the original image. FIG. 14 shows how a picture of a flower could be decomposed into basic graphical building blocks.

### Business Models

Possible business models that could be built around this:
Making it possible to “brand” user interfaces. It could be interesting for service providers, companies and others to be able to affect the user interface of users' devices. An example of this could be companies making an SMS they send to a user appear in the companies colors.
Selling user interface key data. Key data that affect the user interface in various ways could be sold to device owners.
Provide UI control for use in Game development.

### Aspects of the Invention

Aspect A: Modifying a user interface by referring to user interface modification algorithms

According to a first aspect a method for modifying a user interface of an apparatus is provided. The method may comprise

receiving user interface key data, said user interface key data comprising at least one reference to at least one user interface modification algorithm,

generating user interface modification data based on said at least one user interface modification algorithm, and

modifying said user interface based on said user interface modification data.

The user interface key data can be interpreted as a small set of data comprising information related to a user interface. For instance, this information can relate to the appearance in terms of color settings, font style, etc, but also to the behavior in terms of schemes for message handling etc.

Further, the user interface modification algorithm may be stored in a memory in said apparatus.

The user interface key data may further comprise at least one reference to a user interface component.

The user interface component may be stored in a memory in said apparatus.

The user interface component may be a graphical object.

The user interface key data may comprise information about how two or more user interface components should be combined.

Further features and advantages may be found in the description above.

### Aspect B: Modifying a User Interface by Referring to User Interface Components

According to a second aspect another method for modifying a user interface of an apparatus is provided. The method may comprise

receiving user interface key data, said user interface key data comprising at least one reference to a user interface component,

retrieving said user interface component from a memory by utilizing said reference,

generating user interface modification data based on said user interface component, and

modifying said user interface based on said user interface modification data.

The user interface component may be interpreted as a user interface building block, or put differently as a frequently occurring user interface component in a user interface. Therefore, by referring to pre-loaded user interface components less data has to be transferred to the apparatus.

The user interface component may be a graphical object.

The user interface key data may comprise information about how two or more user interface components should be combined.

The user interface component may be stored in a memory in said apparatus.

The user interface key data may further comprise at least one reference to a user interface modification algorithm.

The user interface modification algorithm may be stored in a memory in said apparatus.

Further features and advantages may be found in the description above.

Aspect C: Generating User Interface Key Data by Referring to a User Interface Modification Algorithm

According to a third aspect a method for generating user interface key data is provided. The method may comprise

receiving user interface data,

determining at least one user interface modification algorithm associated to said user interface data,

generating at least one reference to said at least one user interface modification algorithm, and

generating user interface key data based on said at least one reference.

The method may further comprise

transmitting said user interface key data to an apparatus configured to receive user interface key data.

The method may further comprise

determining at least one start value for said at least one user interface modification algorithm,

wherein said step of generating user interface key data is based on

said at least one reference to said at least one user interface modification algorithm, and

said at least one start value.

The method may further comprise

determining at least one user interface component associated to said user interface data,

generating at least one reference to said at least one user interface component,

wherein said step of generating user interface key data is based on
said at least one reference to said at least one user interface modification algorithm, and
said at least one reference to said at least one user interface component.

The method may further comprise

determining at least one user interface component associated to said user interface data,

generating at least one reference to said at least one user interface component,

wherein said step of generating user interface key data is based on
said at least one reference to said at least one user interface modification algorithm,
said at least one start value, and
   said at least one reference to said at least one user interface component.

Further features and advantages may be found in the description above.

Aspect D: Generating User Interface Key Data by Referring to a User Interface Component

According to a fourth aspect another method for generating user interface key data is provided. The method may comprise

receiving user interface data,

determining at least one user interface component associated to said user interface data,

generating at least one reference to said at least one user interface component,

generating user interface key data based on said at least one reference.

The method may further comprise

transmitting said user interface key data to an apparatus configured to receive user interface key data.

The method may further comprise

determining at least one user interface modification algorithm associated to said user interface data.

generating at least one reference to said at least one user interface modification algorithm,

wherein said step of generating user interface key data is based on
said at least one reference to said at least one user interface component, and
said at least one reference to said at least one user interface modification algorithm.

The method may further comprise

determining at least one start value for said at least one user interface modification algorithm,

generating at least one reference to said at least one user interface component,

wherein said step of generating user interface key data is based on
said at least one reference to said at least one user interface modification algorithm,
said at least one start value, and said at least one reference to said at least one user interface component.

Further features and advantages may be found in the description above.

### Aspect E: Generating User Interface Key Data by Iteration

According to a fifth aspect a method for generating user interface data is provided. The method may comprise

selecting a first set of user interface modification algorithms,

selecting at least one start value for said first set of user interface modification algorithms,

generating a first version of a user interface based on said user interface modification algorithms and said start values,

presenting said first version of said user interface,

receiving a first user input actuation indicating an approval or a rejection of said first version of said user interface,

in case said first user input actuation indicates a rejection of said first version of said user interface,
receiving a second user input actuation indicating a second set of user interface modification algorithms, and
generating a second version of said user interface based on said second set of user interface modification algorithms,

in case said first user input actuation indicates an approval of said first version of said user interface,

transforming said first version of said user interface to user interface key data.

### Aspect F. Generating User Interface Key Data by Iteration

According to a sixth aspect another method for generating user interface data is provided. The method may comprise

selecting a set of user interface modification algorithms,

selecting at least one start value for said set of user interface modification algorithms,

generating a first version of a user interface based on said user interface modification algorithms and said start values,

presenting said first version of said user interface,

receiving a first user input actuation indicating an approval or a rejection of said first version of said user interface,

in case said first user input actuation indicates a rejection of said first version of said user interface,
receiving a second user input actuation indicating at least one new start value, and
generating a second version of said user interface based on said at least one new start value,

in case said first user input actuation indicates an approval of said first version of said user interface,

transforming said first version of said user interface to user interface key data.

### Aspect G: Generating User Interface Key Data

According to a seventh aspect a method for generating user interface key data is provided. The method may comprise

receiving a first user input actuation,

generating a first set of user interface key data based on said first user input actuation,

generating a first version of a user interface based on said first set of user interface key data,

presenting said first version of said user interface, wherein said first version of said user interface is based on said first version of user interface key data,

receiving a second user input actuation, generating a second set of user interface key data based on said second user input actuation,

generating a second version of said user interface based on said first set of user interface key data and said second set of user interface key data, and

presenting a second version of said user interface.

All the above aspects are described as methods, but as is apparent from the appended claims, the aspects may also be described as apparatuses. Further, the different apparatuses may be combined into systems.

Generally, all terms used in the claims and the text are to be interpreted according to their ordinary meaning in the technical field, unless explicitly defined otherwise herein. All references to “a/an/the [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

1-50. (canceled)

51. A method for modifying a user interface of an apparatus, said method comprising:
receiving user interface key data, said user interface key data comprising at least one reference to at least one user interface modification algorithm or to a user interface component or to both;
generating user interface modification data based on said at least one user interface modification algorithm or said user interface component or both; and
modifying said user interface based on said user interface modification data.

52. The method according to claim 51, wherein said user interface modification algorithm or said user interface component or both are stored in a memory in said apparatus.

53. The method according to claim 51, wherein said user interface component is a graphical object.

54. The method according to claim 51, wherein said user interface key data comprises information about how two or more user interface components should be combined.

55. The method according to claim 51, further comprising:
receiving user interface data;
determining at least one user interface modification algorithm associated to said user interface data or at least one user interface component associated to said user interface data or both;
generating at least one reference to said at least one user interface modification algorithm or said at least one user interface component or both;
generating user interface key data based on said at least one reference.

56. The method according to claim 55, further comprising transmitting said user interface key data to an apparatus configured to receive user interface key data.

57. The method according to claim 55, further comprising:
determining at least one start value for said at least one user interface modification algorithm;
wherein said step of generating user interface key data is based on:
said at least one reference to said at least one user interface modification algorithm; and
said at least one start value.

58. The method according to claim 55, further comprising:
determining at least one start value for said at least one user interface modification algorithm;
wherein said step of generating user interface key data is based on:
said at least one reference to said at least one user interface modification algorithm;
said at least one start value; and
said at least one reference to said at least one user interface component.

59. The method according to claim 51, further comprising:
selecting a first set of user interface modification algorithms;
selecting at least one start value for said first set of user interface modification algorithms;
generating a first version of a user interface based on said first set of user interface modification algorithms and said at least one start value;
presenting said first version of said user interface,
receiving a first user input actuation indicating an approval or a rejection of said first version of said user interface;
in case said first user input actuation indicates a rejection of said first version of said user interface,
receiving a second user input actuation indicating a second set of user interface modification algorithms or at least one new start value or both; and
generating a second version of said user interface based on said second set of said set of user interface modification algorithms or said at least one new start value or both;
in case said first user input actuation indicates an approval of said first version of said user interface,
transforming said first version of said user interface to user interface key data.

60. The method according to claim 51, further comprising
receiving a first user input actuation;
generating a first set of user interface key data based on said first user input actuation;
generating a first version of a user interface based on said first set of user interface key data;
presenting said first version of said user interface, wherein said first version of said user interface is based on said first version of user interface key data;
receiving a second user input actuation;
generating a second set of user interface key data based on said second user input actuation;
generating a second version of said user interface based on said first set of user interface key data and said second set of user interface key data; and
presenting a second version of said user interface.

61. The method according to claim 60, wherein said first set of user interface key data is unchanged in said step of generating a second version of user interface key data.

62. An apparatus comprising:
a user interface key data receiver configured to receive user interface key data comprising at least one reference to at least one user interface modification algorithm or to a user interface component or to both;
a user interface modification data generator configured to generate user interface modification data based on said at least one user interface modification algorithm or said user interface component or both; and
a user interface modifier configured to modify said user interface based on said user interface modification data.

63. The apparatus according to claim 62, wherein said user interface modification algorithm or said user interface component or both are stored in a memory in said apparatus.

64. The apparatus according to claim 62, wherein said user interface component is a graphical object.

65. The apparatus according to claim 62, wherein said user interface key data comprises information about how two or more user interface components should be combined.

66. The apparatus according to claim 62, further comprising:
a user interface data receiver configured to receive user interface data;
a user interface algorithm determinator configured to determine at least one user interface modification algorithm associated to said user interface data;
a reference generator configured to generate at least one reference to said at least one user interface modification algorithm; and
a user interface key data generator configured to generate user interface key data based on said at least one reference.

67. The apparatus according to claim 66, further comprising:
a user interface key data transmitter configured to transmit said user interface key data to an apparatus configured to receive user interface key data.

68. The apparatus according to claim 66, further comprising:
a start value determinator configured to determine at least one start value for said at least one user interface modification algorithm,
wherein said user interface key data generator utilizes:
said at least one reference to said at least one user interface modification algorithm, and
said at least one start value.

69. The apparatus according to claims 66, further comprising:
a user interface component determinator configured to determine at least one user interface component associated to said user interface data;
a reference generator configured to generate at least one reference to said at least one user interface component,
wherein said user interface key data generator utilizes:
said at least one reference to said at least one user interface modification algorithm, and
said at least one reference to said at least one user interface component.

70. The apparatus according to claim 66, further comprising:
a user interface component determinator configured to determine at least one user interface component associated to said user interface data;
a reference generator configured to generate at least one reference to said at least one user interface component;
a start value determinator configured to determine at least one start value for said at least one user interface modification algorithm;
wherein said user interface key data generator utilizes:
said at least one reference to said at least one user interface modification algorithm,
said at least one start value, and
said at least one reference to said at least one user interface component.

71. The apparatus according to claim 62, further comprising:
a user interface data receiver configured to receive user interface data;
a user interface component determinator configured to determine at least one user interface component associated to said user interface data;
a reference generator configured to generate at least one reference to said at least one user interface component; and
a user interface key data generator configured to generate user interface key data based on said at least one reference.

72. The apparatus according to claim 71, further comprising:
a user interface key data transmitter configured to transmit said user interface key data to an apparatus configured to receive user interface key data.

73. The apparatus according to claim 62, further comprising:
a user interface modification algorithms selector configured to select a first set of user interface modification algorithms;
a start value selector configured to select at least one start value for said first set of user interface modification algorithms;
a user interface generator configured to generate user interfaces based on said user interface modification algorithms and said start values;
a user interface presenter configured to present user interfaces;
a user input actuation receiver configured to receive user input actuation; and
a user interface modification handler configured, in case a first user input actuation indicates a rejection of a first version of said user interface based on said first set of user interface modification algorithms, to enable said user input actuation receiver to receive a second user input actuation indicating a second set of said set of user interface modification algorithms or at least one new start value or both, and to instruct said user interface generator to generate a second version of said user interface based on said second set of user interface modification algorithms or said at least one new start value or both, and,
in case said first user input actuation indicates an approval of said first version of said user interface, instruct a user interface transformer to transform said first version of said user interface to user interface key data.

74. The apparatus according to claim 62, further comprising:
a user input actuation receiver configured to receive user input actuations;
a user interface key data generator configured to generate a first set and a second set of user interface key data based on a first and a second user input actuation, respectively;
a user interface key data generator configured to generate a first version of user interface key data based on said first set of user interface key data, and to generate a second version of said user interface based on said first set of user interface key data and said second set of user interface key data;
a user interface presenter configured to present said first version and said second version of said user interface; and
a user interface handler configured to enable said user input actuation receiver to receive said second user input actuation in case said first version of said user interface has been presented by said user interface presenter.

75. The apparatus according to claim 74, wherein said first set of user interface key data is unchanged in said step of generating a second version of user interface key data.

76. A method comprising:
receiving user interface data;
determining at least one user interface modification algorithm associated to said user interface data or at least one user interface component associated to said user interface data or both;
generating at least one reference to said at least one user interface modification algorithm or said at least one user interface component or both;
generating user interface key data based on said at least one reference.

77. An apparatus comprising:
a user interface data receiver configured to receive user interface data;
a determinator configured to determine at least one user interface modification algorithm associated to said user interface data or to determine at least one user interface component associated to said user interface data or both;
a reference generator configured to generate at least one reference to said at least one user interface modification algorithm or said at least one user interface component or both; and
a user interface key data generator configured to generate user interface key data based on said at least one reference.
